(19) United States
(12) Patent Application Publication
(10) Pub. No.: US 2011/0182709 A1
(43) Pub. Date: Jul. 28, 2011

(54) Method for Speed Optimizing a Robot

(75) Inventor: Guenther Weber, Gross Nemerow (DE)

(73) Assignee: Weber Maschinenbau GmbH Breidenbach, Breidenbach (DE)

(21) Appl. No.: 12/975,109

(22) Filed: Dec. 21, 2010

(30) Foreign Application Priority Data
Dec. 22, 2009 (DE) 10 2009 060 062.0

(51) Int. Cl. G05B 19/00; B25J 9/00

(52) U.S. Cl. 414/751.1; 700/250; 901/2

(57) ABSTRACT

The invention relates to a method for speed optimizing a robot which is configured to carry out a plurality of product transfer procedures which follow one another and in which products are transferred from a pick-up region into a placement region, wherein at least one first transfer procedure is repeatedly carried out at which a first kind of product is picked up at a first predetermined pick-up location of the pick-up region and is placed down at a first predetermined placement location of the placement region, in which method an upper limit for the permitted kinematic load on the robot is defined and the speed at which the first transfer procedure is carried out is increased, starting from a starting speed at which the resulting kinematic load on the robot is in any case below the defined upper limit, during a teaching phase on every repetition of the first transfer procedure up to an ideal working speed at which the resulting kinematic load corresponds at least approximately to the defined upper limit. The invention also relates to a robot having a robot control for carrying out the method.

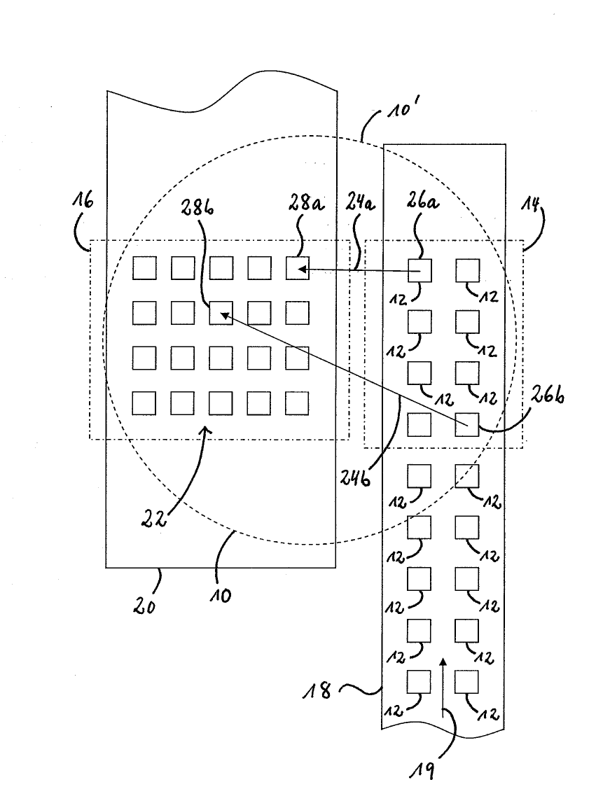

The invention relates to a method for speed optimizing a robot which is configured to carry out a plurality of product transfer procedures which follow one another and in which products are transferred from a pick-up region into a placement region, wherein at least one first transfer procedure is repeatedly carried out in which a first kind of product is picked up at a first predetermined pick-up location of the pick-up region and is placed down at a first predetermined placement location of the placement region.

Robots are today used in the most varied areas in order inter alia to improve the ergonomics of workplaces, to save personnel, to handle heavy loads and/or to increase the process speed.

The movements of a robot have to be carried out at maximum speed to achieve a higher process speed. To avoid unnecessarily high kinematic loads on the robot in so doing, in particular the accelerations and torques which arise should always be kept beneath respective permitted limit values.

It is known for this purpose to calculate kinematic loads on the robot to be expected in advance or during a respective movement with reference to existing data such as the trajectory planning, the robot geometry, the moved masses, etc. It applies in this respect that the calculated loads may not exceed the permitted limit values at any time.

This method has the disadvantage that relevant data such as centers of mass, masses of inertia, etc. must be very accurately determined beforehand. This procedure is furthermore very processor intensive. To prevent the calculation procedure from already representing a speed-limiting restriction considered per se, high processor performances are required.

Alternative solution approaches refrain from monitoring the kinematic loads on the robot which occur in operation, which can admittedly have the consequence of high work speeds, but in turn also of a reduced service life of the robot.

It is the underlying object of the invention to optimize the working speed of a robot without reducing the service life of the robot in so doing.

A method having the features of claim 1 is provided to achieve the object.

The method in accordance with the invention serves for speed optimizing a robot which is configured to carry out a plurality of product transfer procedures which follow one another and in which products are transferred from a pick-up region into a placement region, wherein at least one first transfer procedure is repeatedly carried out in which a first kind of product is picked up at a first predetermined pick-up location of the pick-up region and is placed down at a first predetermined placement location of the placement region.

Such a robot can, for example, be a delta robot such as is used in the food industry to transfer food products from a first transport belt to a second transport belt or into a packaging. Other types of robots can, however, generally also be considered with the specific design of the robot ultimately not being important. What is rather decisive is that the robot serves to carry out a transfer procedure or a plurality of transfer procedures in multiple repetition.

The expression “transfer procedure” in this context designates a predetermined travel path of the robot which is in particular defined by the associated pick-up location and placement location. A first transfer procedure can thus, for example, be defined by a first pick-up location A1 and a first placement location B1, whereas a second transfer procedure is defined by a second pick-up location A2 and a second placement location B2, wherein the second pick-up location A2 may be identical to the first pick-up location A1.

In the method in accordance with the invention, an upper limit for the permitted kinematic load on the robot is defined and the speed at which the first transfer procedure is carried out, starting from a starting speed at which the resulting kinematic load on the robot in any case lies beneath the defined upper limit increases during a teaching phase of the robot with each repetition of the first transfer procedure up to an ideal speed at which the resulting kinematic load at least approximately corresponds to the defined upper limit.

It is not necessary in accordance with the invention to determine the mass and the center of mass of a product to be transferred and to calculate a maximum permitted working speed from these data with knowledge of the travel path and of an upper limit for the kinematic load not to be exceeded. The invention rather provides a teaching phase after every new start of the robot during which the robot becomes faster, starting from a comparatively slow starting speed, with every repetition of a transfer procedure until it has reached its ideal working speed at which the resulting kinematic loads are as close as possible to the defined upper load limit, preferably without exceeding it. The robot therefore sets itself so-to-say during the teaching phase.

As a result, the method in accordance with the invention therefore makes possible in a simple manner and in particular with a minimal calculation effort a maximization of the working speed of a robot without there being in this respect the risk of an overload of the robot mechanics by which the service life of the robot would be reduced. The invention thus results in a particularly efficient and low-wear operation of a robot, whereby ultimately the cost-effectiveness of the robot is improved.

Advantageous embodiments of the invention can be seen from the dependent claims, from the description and from the drawing.

In accordance with an embodiment, a second transfer procedure is carried out repeatedly in which a second kind of product is picked up at a second predetermined pick-up location of the pick-up region and is placed down at a second predetermined placement location of the pick-up region. In this respect, the speed at which the second transfer procedure is carried out, starting from a starting speed at which the resulting kinematic load on the robot is in any case beneath the defined upper limit is increased during a teaching phase with every repetition of the second transfer procedure up to an ideal speed at which the resulting kinematic load corresponds at least approximately to the defined upper limit.

In other words, a respective separate teaching phase is provided not only for the first transfer procedure, but also for the second transfer procedure and optionally for further transfer procedures. As has already been mentioned, the different transfer procedures differ in their pick-up location and/or placement location. In addition, the first kind of product and the second kind of product can be the same or different depending on the application.

The increase in the speed at which the second transfer procedure is carried out advantageously takes place independently of the increase in the speed at which the first transfer procedure is carried out. Spoken generally, the speeds of different transfer procedures are therefore preferably optimized independently of one another. This enables an ideal setting of the speed of every single transfer procedure, which ultimately contributes to a particularly efficient and low-wear mode of operation of the robot and increases its cost-effectiveness even further.

To be able to check whether the speed of a transfer procedure can be increased still further on its next repetition, the resulting kinematic load on the robot is determined and compared with the defined upper load limit at least during the teaching phase of a transfer procedure. If the determined kinematic load has reached the defined upper load limit, the speed of the transfer procedure is not further increased and the teaching phase is ended.

It is generally not necessary after the end of the teaching phase, i.e. in the stationary operation of the robot, again to determine the resulting kinematic load. It is, however, by all means conceivable to check the kinematic load which occurs during a transfer procedure at a later time for monitoring purposes so that it can be ensured that the robot permanently works in the ideal range.

The resulting kinematic load is preferably determined from relevant robot parameters which are detected during the respective transfer procedure. As has already been mentioned, no knowledge of the mass or of the center of mass of the product to be transferred is necessary for determining the resulting kinematic load, which contributes to the fact that the optimization of the working speed of the robot manages with a minimal processing effort.

The relevant robot parameters can, for example, include: a maximum speed of a movable part of the robot provided for transferring the product, an acceleration of the moving part, a torque required for moving the moving part and/or a power consumption of a drive for moving the moving part. The moving part of the robot can e.g. be a pivotable arm of the robot to which a tool for gripping the product is attached.

The relevant robot parameters detected during a transfer procedure are advantageously stored and are used at least during the teaching phase of the transfer procedure as a basis for the increase in the working speed on the next repetition of the transfer procedure. To ensure that the defined upper load limit is at least not substantially exceeded during the teaching phase, maximum peg mitted limit values for the individual relevant robot parameters can be defined which must be observed on the increase of the speed of a transfer procedure.

It is generally of advantage if the speed of a transfer procedure is increased in that the maximum speed and/or acceleration of a moving part of the robot provided for transferring the product is/are increased in accordance with a predetermined scheme. An increase in constant steps or also a percentage increase is conceivable in this respect.

A further subject of the invention is a robot having the features of claim 10, in particular having a robot control which is configured to carry out the method in accordance with the invention. The advantages of the invention described above in connection with the method consequently apply accordingly to the robot.

The invention will be described in the following purely by way of example with reference to an advantageous embodiment and to the enclosed drawing.

The only Figure shows a workstation having a robot 10 whose work speed can be optimized in accordance with the invention.

In this example, the robot 10, which is shown purely schematically by its circle of action 10′, is a delta robot, with generally other types of robots also being able to be considered. The robot 10 serves to transfer products 12 from a pick-up region 14 into a placement region 16.

The products 12 are food products, for example portions of ham slices, sausage slices or cheese slices, which have been cut up in a cutting apparatus, e.g. in a high-speed slicer, from a product loaf of, for example, bar shape, and have been transported by means of a transport device 18, e.g. a conveyor belt, in a direction shown by the arrow 19 into the pick-up region 14.

In accordance with the embodiment shown, the products 12 are fed to the pick-up region 14 in two rows. The products 12 can, however, generally also be transported on the transport apparatus 18 in only one row or in more than two rows.

When the products reach the pick-up region 14, they are picked up by the robot 10 and placed down in the placement region 16, in this embodiment in a packaging machine 20, where they are combined in accordance with a predetermined scheme into a format set 22 which is formed in this example from 5×4 products 12. It is self-explanatory that the design of the format set 22 can differ from a “5×4 arrangement”.

Once a format set 22 has been completed, it is moved out of the circle of action 10′ of the robot 10 so that the following products 12 can be combined into a new format set 22. One format set 22 after the other is completed in this manner.

During the formation of a format set 22, the robot 10 carries out a series of predetermined transfer procedures 24 which are each defined by the pairing of the pick-up location and the placement location of a product 12. Since the format set 22 in the present embodiment comprises 5×4 products 12, the robot carries out a total of twenty different transfer procedures.

For reasons of better clarity, only two of these are shown in the Figure, namely a first transfer procedure 24a in which a product 12 is picked up at a first pick-up location 26a and is placed down at a first placement location 28a as well as a second transfer procedure 24b in which a product 12 is picked up at a second pick-up location 26b and is placed down at a second placement location 28b.

The robot 10 has to work at maximum speed to achieve a transfer of the products 12 into the packaging machine 20 which is as fast as possible. In this respect, however, excessive kinematic loads on the robot are to be avoided in order not unnecessarily to shorten the service life of the robot 10. It is therefore necessary to optimize the speed of the robot 10 so that the individual transfer procedures 24 are carried out at maximum speed without the robot mechanics being overloaded in this process.

For this purpose, an upper limit for the maximum permitted kinematic load on the robot 10 is defined which is preferably selected so that the service life of the robot 10 is also at least not substantially impaired on a regular reaching of the upper load limit. For reasons of simplicity, the upper load limit applies globally, i.e. to all possible transfer procedures 24 of the robot 10. It is, however, generally also conceivable to define different upper load limits for every individual transfer procedure 24 or at least for groups of transfer procedures 24.

On a start of the robot 10, the transfer procedures 24 belonging to the first format set 22 are first carried out at a comparatively slow starting speed at which it is anyway ensured that the respective resulting kinematic loads on the robot mechanics lie below the defined upper load limit.

Relevant robot parameters such as the maximum speed reached of a movable part of the robot 10, e.g. a robot arm, the accelerations of the movable part which occur, arising torques, the power consumption of a drive for moving the moving part, etc. are measured during each of these transfer procedures 24 to calculate the kinematic load on the robot mechanics occurring in each case during a transfer procedure 24 from them. The relevant robot parameters determined for each transfer procedure 24 are stored and the calculated kinematic load is compared with the defined upper load limit.

During the following cycles, i.e., that is during the formation of the following format sets 22, the speeds at which the individual transfer procedures 24 are carried out are successively increased, with here in each case also the relevant robot parameters being detected and stored and the correspondingly occurring kinematic loads being calculated therefrom.

The speeds of the transfer procedures 24 are increased for so long from format set 22 to format set 22, i.e. that is from repetition to repetition, until the determined kinematic load for each of the different transfer procedures 24 at least approximately reaches the defined upper load limit or at least does not substantially exceed it. The thus achieved working speeds represent ideal working speeds at which every single transfer procedure 24 is carried out at maximum speed without the robot mechanics being excessively loaded in so doing.

The robot 10 therefore so-to-say sets itself to ideal working speeds by the running through of a teaching phase. It must be pointed out in this respect that the teaching phases of the different transfer procedures 24 do not necessarily have to be of equal length. It is thus by all means conceivable that the ideal working speed for one transfer procedure 24 is reached faster than for a different transfer procedure 24. The ideal working speed for the transfer procedure 24a can, for example, already be reached after four format sets 22, whereas it is only achieved after six or seven format sets 22 for the transfer procedure 24b.

### REFERENCE NUMERAL LIST

10 robot
10′ circle of action
12 product
14 pick-up region
16 placement region
18 transport apparatus
19 transport direction
20 packaging machine
22 format set
24 transfer procedure
26 pick-up location
28 placement location

1. A method for speed optimization of a robot (10) which is configured to carry out a plurality of product transfer procedures which follow one another and in which products (12) are transferred from a pick-up region (14) into a placement region (16), wherein at least one first transfer procedure (24a) is repeatedly carried out in which a first kind of product (12) is picked up at a first predetermined pick-up location (26a) of the pick-up region (14) and is placed down at a first predetermined placement location (28a) of the placement region (16), in which method
an upper limit for the permitted kinematic load on the robot (10) is defined; and
the speed at which the first transfer procedure (24a) is carried out, starting from a starting speed at which the resulting kinematic load on the robot is in any case below the defined upper limit, is increased during a teaching phase at every repetition of the first transfer procedure (24a) up to an ideal speed at which the resulting kinematic load at least approximately corresponds to the defined upper limit.

2. A method in accordance with claim 1,
characterized in that
a second transfer procedure (24b) is repeatedly carried out at which a second kind of product (12) is picked up at a second predetermined pick-up location (26b) of the pick-up region (14) and is placed down at a second predetermined placement location (28b) of the placement region (16), with the speed at which the second transfer procedure (24b) is carried out being increased, starting from a starting speed at which the resulting kinematic load on the robot (10 is in any case below the defined upper limit, during a teaching phase at every repetition of the second transfer procedure (24b) up to an ideal speed at which the resulting kinematic load at least approximately corresponds to the defined upper limit.

3. A method in accordance with claim 2,
characterized in that
the increase in the speed at which the second transfer procedure (24b) is carried out takes place independently of the increase in the speed at which the first transfer procedure (24a) is carried out.

4. A method in accordance with claim 1,
characterized in that,
at least during the teaching phase of a transfer procedure (24), the resulting kinematic load on the robot is determined and is compared with the defined upper limit.

5. A method in accordance with claim 1,
characterized in that
the resulting kinematic load is determined from relevant robot parameters which are detected during the respective transfer procedure (24).

6. A method in accordance with claim 5,
characterized in that
the relevant robot parameters include: a maximum speed of a moving part of the robot (10) provided for transferring the product (12), an acceleration of the moving part, a torque required for moving the moving part and a power consumption of a drive for moving the movable part.

7. A method in accordance with claim 5,
characterized in that
the relevant robot parameters detected during a transfer procedure (24) are stored and are used at least during the teaching phase of the transfer procedure (24) as the basis for the increase in the speed on the next repetition of the transfer procedure (24).

8. A method in accordance with claim 5,
characterized in that
maximum permitted limit values for the relevant robot parameters are defined which have to be observed on the increase in the speed of a transfer procedure (24).

9. A method in accordance with claim 1,
characterized in that
the speed of a transfer procedure (24) is increased in that the maximum speed and/or acceleration of a moving part of the robot provided for transferring the product (12) is/are increased in accordance with a predetermined scheme.

10. A robot (10) which is configured to carry out a plurality of product transfer procedures (24) which follow one another and in which products (12) are transferred from a pick-up region (14) into a placement region (16), wherein at least one first transfer procedure (24) is repeatedly carried out at which a first kind of product (12) is picked up at a first predetermined pick-up location (26) of the pick-up region (14) and is placed down at a first predetermined placement location (26) of the placement region (16), comprising a robot control which is configured to carry out a method wherein at least one first transfer procedure (24a) is repeatedly carried out in which a first kind of product (12) is picked up at a first predetermined pick-up location (26a) of the pick-up region (14) and is placed down at a first predetermined placement location (28a) of the placement region (16), wherein an upper limit for the permitted kinematic load on the robot (10) is defined; and wherein the speed at which the first transfer procedure (24a) is carried out, starting from a starting speed at which the resulting kinematic load on the robot is in any case below the defined upper limit, is increased during a teaching phase at every repetition of the first transfer procedure (24a) up to an ideal speed at which the resulting kinematic load at least approximately corresponds to the defined upper limit.
